(19) United States
(12) Patent Application Publication
(10) Pub. No.: US 2010/0255326 A1
(43) Pub. Date: Oct. 7, 2010

(54) PRINTABLE GAS BARRIERS

(75) Inventors: Emanuela Chiappini, Offida (AP) (IT); Stefano Gardi, Bologna (IT); Andrew J. Naisby, Salzburg (AT); Rosanna Telesca, Basel (CH); Walter Taplin, Hockessin, DE (US); Neil Forsythe, Landenberg, PA (US)

Correspondence Address: BASF Corporation;Patent Department, 500 White Plains Road, P.O. Box 2005, Tarrytown, NY, 10591, US

(73) Assignee: CIBA CORPORATION, Tarrytown, NY (US)

(21) Appl. No.: 12/573,467

(22) Filed: Oct. 5, 2009

Related U.S. Application Data
(60) Provisional application No. 61/195,414, filed on Oct. 7, 2008.

(51) Int. Cl. B32B 27/30; B05D 3/06; B05D 3/02; B05D 3/04; C08J 3/28; C08L 33/24; C08F 2/46

(52) U.S. Cl. 428/474.4; 427/508; 427/496; 427/385.5; 427/535; 522/112; 525/218; 522/33

(57) ABSTRACT

A method is provided for enhancing the gas barrier properties of substrates such as materials used in packaging, by applying a composition comprising a vinyl alcohol/vinyl amide copolymer, a cross linker and, optionally, a diacrylate or other polyacrylate and a photo initiator to the material and curing the composition by irradiation with UV light, visible light, IR irradiation and/or electron beam or by exposure to heat. The method includes the optional step of subjecting the material to a low-temperature plasma discharge or a corona discharge prior to applying the composition. The method provides, for example, packaging materials, such as, flexible packaging materials such as plastic films producing packaging materials with excellent gas barrier properties, for example oxygen barrier properties, which are readily printed upon.

This application claims benefit under 35 USC 119(e) of U.S. provisional application No. 61/195,414, filed Oct. 7, 2008, the disclosure of which is incorporated herein in its entirety by reference.

The gas barrier properties of substrates, such as materials used in packaging, are enhanced by applying a composition comprising a vinyl alcohol/vinyl amide copolymer, a cross linker and, optionally, a diacrylate or other polyacrylate and a photo initiator to the material, and crosslinking the composition, either by photo curing, that is exposure to irradiation by UV light, visible light, IR irradiation and/or electron beam, or by thermal crosslinking. Optionally, the material may be subjected to a low-temperature plasma discharge or a corona discharge prior to applying the composition. The method provides, for example, flexible packaging materials such as plastic films, with excellent gas barrier properties, such as oxygen barrier properties, and excellent printability.

### BACKGROUND

Packaging materials, such as those for packaging food, medicine, etc., are often used to protect their contents from aging or spoilage. Polyvinyl alcohol polymers are known to act as oxygen barriers and are frequently encountered in packaging, often as a coating or laminate for flexible packaging materials, to prevent spoilage due to the action of oxygen. PVA is water soluble and can be applied as a coating or laminate for packaging materials without the use of organic solvents or dispersing agents. However, PVA is highly sensitive to water and as relative humidity increases, PVA becomes more permeable to oxygen presumably due to disruption of the polymer film's crystallinity.

Attempts to overcome the water or humidity sensitivity of PVA have been made. For example, cross-linking PVA has been used to increase the water resistance of a film made of PVA. For example, a cross-linking method employing an isocyanate compound or boric acid is known. Other methods using a wide variety of cross linkers are also well known.

PVA co-polymers, prepared by co-polymerization of vinyl acetate and other vinyl monomers followed by hydrolysis of at least a portion of the acetate groups, are also known and can be used as oxygen barriers. Cross linking to decrease water sensitivity with such copolymers has also been employed.

U S Pub. Pat. Appl. 20060116471, incorporated herein in its entirety by reference, discloses a water soluble resin composition, useful as a gas barrier film and packaging material containing a vinyl alcohol/vinyl amine copolymer and a cross linker having functional groups capable of reacting with amino groups selected from the group consisting of materials formed by a reaction of a secondary amino group with epichlorohydrin, acetoacetyl groups, acid anhydride groups, formamide groups and ester groups. For example, cross-linkers include a polyamide-epichlorohydrin resin, an acetoacetylated poly(vinyl alcohol), a copolymer of maleic anhydride with methyl vinyl ether, a copolymer of maleic anhydride with isobutylene with maleic anhydride, a poly(N-vinylformamide), a (N-vinylformamide) copolymer, and a multifunctional ester.

It is also desirable that packaging materials can be printed on. PVA polymers and copolymers also readily accept ink, such as water based inks, and are used as components in ink receptive materials, such as ink jet media. Water sensitivity can also create problems for the permanence of printed images, for example, images with poor wash fastness may result.

Co-pending U.S. patent application Ser. No. 11/715,779, incorporated herein in its entirety by reference, discloses ink jet media comprising a vinyl alcohol/vinyl amide co-polymer which displays excellent printing characteristics. The co-polymer is typically present in a layer applied to a support, for example paper or a rigid or flexible plastic sheet of film. The layer comprising the vinyl alcohol/vinyl amide co-polymer may also be advantageously cross linked to limit or adjust the solubility of the layer.

U.S. Pat. No. 6,548,121 and co-pending U.S. patent application Ser. No. 10/502,208, incorporated herein in their entirety by reference, disclose methods for producing strongly adherent coatings on a substrate that comprise subjecting the substrate to a low-temperature plasma discharge, a corona discharge etc, applying one or more photo initiators containing at least one ethylenically unsaturated group, or a mixture of photo initiator(s) with monomer(s) to the treated substrate, before applying a coating layer. U.S. Pat. No. 6,048,660, the disclosure of which is incorporated in its entirety by reference, discloses phenylglyoxalic ester photo initiators and compositions which are useful, for example, in forming these strongly adherent coatings.

As referenced above, one major drawback to polyvinyl alcohol as an oxygen barrier is its sensitivity to changes in relative humidity. As relative humidity increases the polymer becomes more permeable to oxygen and its barrier properties deteriorate. The present invention overcomes this liability providing easily prepared films of crosslinked poly vinylalcohol copolymer compositions which demonstrate good oxygen barrier properties at low and high humidity levels.

### SUMMARY OF THE INVENTION

The present invention provides a method for enhancing the gas barrier properties of materials, such as packaging materials, for example, flexible packaging materials such as plastic films, which method comprises applying to at least one surface of the material a composition comprising:
A) a vinyl alcohol/vinyl amide copolymer
B) a crosslinking agent, for example, a vinyl alcohol polymer or copolymer bearing groups capable of reacting with the vinyl alcohol/vinyl amide copolymer of A
C) optionally a multifunctional acrylate, for example a di-, tri-, tetra-acrylate etc, and/or a photo initiator, and
   effecting crosslinking by either photo curing the composition by irradiation with UV light, visible light, electron beam and/or exposing the composition to heat.

For example, the method improves barrier properties of materials toward gasses such as oxygen, carbon dioxide and chlorine etc, one particular embodiment is directed at oxygen.

In the method, the material may optionally be subjected to a low-temperature plasma discharge or a corona discharge prior to applying the composition.

While the cross linker Component B may comprise almost any cross linking agent that contains at least two groups that will react with the copolymer A, excellent results are achieved when Component B is a vinyl alcohol polymer or copolymer which acts as a crosslinker with Copolymer A, for example, acetoacetylated poly(vinyl alcohol). In certain embodiments using a vinyl alcohol polymer or copolymer as a crosslinking agent, the amount of component B in the composition equals or exceeds the amount of vinyl alcohol/vinyl amide copolymer A.

Also provided is a composition comprising the components A, B and optionally C as described above wherein the vinyl alcohol/vinyl amide co-polymer of component A comprises less than 2 mole % of amine containing monomer units and the cross linker is a polymeric resin, for example, a modified poly(vinyl alcohol) such as an acetoacetylated poly(vinyl alcohol), which composition can form a free standing film with excellent gas barrier properties, for example, oxygen barrier properties, or can be applied to the surface of a substrate forming a coating layer with excellent gas barrier properties when cured, i.e., crosslinked, by applying heat, irradiation by UV light, visible light, IR irradiation and/or electron beam.

The films or layers of the invention have excellent adhesion, durability and printability characteristics and are readily printed upon using common commercial techniques.

### DESCRIPTION OF THE INVENTION

Thus, a method is provided for enhancing the gas barrier properties of a substrate, for example, the oxygen barrier properties of a substrate such as a packaging material, for example, a flexible packaging material such as a plastic film, for example, a film of poly lactic acid (PLA) or poly ethyleneterephtalate (PET), which method comprises applying to at least one surface of the substrate a composition comprising:

A) a vinyl alcohol/vinyl amide co-polymer comprising monomer units of formulae (I) and (II)

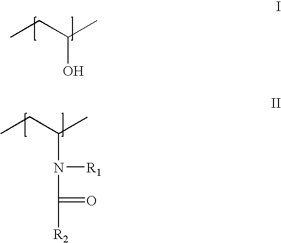

wherein R₁ and R₂ are independently H or C₁-C₁₂ alkyl, for example H or C₁-C₆ alkyl, for example at least one of R₁ and R₂ is H, often both are H;
which copolymer contains less than 6 mole percent, for example from 0-6%, 0-5%, 0-3%, 0-2% or 0-1% of a repeating unit containing an amino group of formula III,

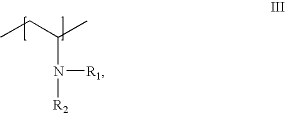

for example a repeating unit of formula III wherein R₁ is H or C₁-C₁₂ alkyl and R₂ is H, such as a monomer unit derived from the hydrolysis of the amide containing unit of formula II,
B) a cross linker containing groups capable of reacting with the vinyl alcohol/vinyl amide copolymer, for example, a vinyl alcohol polymer or copolymer bearing groups capable of reacting with the vinyl alcohol/vinyl amide copolymer of A,
C) optionally a multifunctional acrylate, for example a di-, tri-, tetra-acrylate etc, and/or a photo initiator, for example a phenyl glyoxalate,
and exposing the composition to irradiation with UV light, visible light, electron beam and/or heat to effect cure, that is, crosslinking.

In the method, the surface of the substrate or material may optionally be subjected to a low-temperature plasma discharge or a corona discharge prior to applying the composition.

Often, UV light and/or visible light is used to cure the composition. Heating may also be employed together with radiation or as a separate step.

In one embodiment, the composition is applied to the substrate as part of a solution or dispersion in water, an organic solvent, or a mixture thereof. For example, the composition is applied as a solution in water.

In another embodiment, the composition is applied to the substrate via thermal processing, such as extrusion, co-extrusion or other melt processing method. For example, the substrate comprises a thermoplastic polymer which may be coextruded with the composition of the invention to form a multi-layer substrate. When applying the composition to the substrate via thermal processing methods, crosslinking may occur during the thermal processing step, e.g., during extrusion or co-extrusion, or in a subsequent heat of photo-curing step.

The vinyl alcohol/vinyl amide co-polymer A may also contain other, additional monomer units. For example, units from unhydrolyzed vinyl ester (IV) are typically present

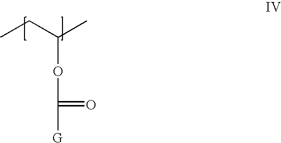

wherein G is C₁-C₁₂ alkyl, for example methyl; and more than one vinyl amide monomer may be used in preparing the copolymer thus incorporating into the copolymer additional, different amide units (V)

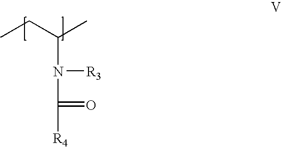

wherein R₃ and R₄ are as described for R₁ and R₂.

Other monomers, such as other vinyl monomers, may also be present during polymerization giving rise to additional repeat units in the copolymer. Groups can also be added to the copolymer hydroxy groups to create various functionalized copolymers.

Often, the copolymer will be a random or block copolymer, generally a random copolymer of the general formula

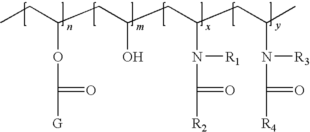

wherein
n is from about 0 to about 20 mole %, for example, from about 2 to about 20 mole %,
m is from about 50 to about 99 mole %, for example, from about 60 to about 96 mole %, for example, from about 68 to about 92 mole %,
x is from about 1 to about 50 mole %, for example, from about 4 to about 20 mole %, for example from about 6 to about 12 mole %, and
y is from about 0 to about 20 mole percent.

Typically, y is 0 and the copolymer is of the formula

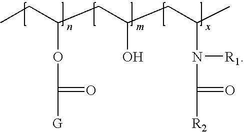

The preceding two formulae are obviously idealized structures and represent only the relative amounts of the various repeat units without any attempt to portray the manner in which the repeat units are attached. Also, the actual copolymers can include a small amount of other species as is encountered with any common polymerization reaction.

The cross linker B can be any cross linker that contains at least two groups that will react with the copolymer A. The groups may be the same or different and include, for example, aldehydes, metal compounds, melamine ethers, halohydrins, groups formed by a reaction of a secondary amino group with epichlorohydrin, acetoacetyl groups, glyoxylates, acid anhydride groups, formamide groups and ester groups. The cross linkers may be small, “monomeric” compounds such as glutaraldehyde, glyoxal, epichlorohydrin or an ammonium zirconium carbonate, or the cross linkers may be dimeric, oligomeric or polymeric compounds containing groups that react with the copolymer.

When using a “monomeric” compound as cross linker, for example, a compound with a molecular weight of less than about 500, the composition will comprise a weight ratio of copolymer to cross linker of about 10 to 1 to about 10,000 to 1.

For example, one embodiment provides a method which comprises applying to at least one surface of the substrate a composition comprising

A) the vinyl alcohol/vinyl amide copolymer,
B) about 0.01% to about 10% by weight, based on the weight of the alcohol/vinyl amide copolymer, of a cross linker compound with a molecular weight of less than about 500, and
C) 0 to 50% by weight, e.g., 1 to 50% based on the weight of the alcohol/vinyl amide copolymer, of a combination containing 15-70 weight % of a multifunctional acrylate, for example a di-, tri-, tetra-acrylate, 30-70 weight % of a photo initiator and 0-10 weight % of a surfactant based on the weight of the combination,
and curing the composition by irradiation or exposure to heat, for example, irradiation with UV light and/or visible light.

In one embodiment of the method, the cross linkers are polymeric resins, for example, a polyamide-epichlorohydrin resin, an acetoacetylated poly(vinyl alcohol), a copolymer of maleic anhydride with methyl vinyl ether, a copolymer of maleic anhydride with isobutylene, a poly(N-vinylformamide), a (N-vinylformamide) copolymer, or a multifunctional ester or ketone.

In one particular embodiment, the cross linker is a poly(vinyl alcohol) which has been modified to include the copolymer reactable groups or is a poly(vinyl alcohol) copolymer, wherein the copolymer reactable groups are incorporated via a co-monomer. For example, the cross linker is acetoacetylated poly(vinyl alcohol) or a PVA copolymer with a vinyl monomer comprising a ketone or ester group, for example a vinyl monomer comprising a nitro benzoyl substituent.

For example, the composition applied to the material to enhance oxygen barrier properties according to the instant method comprises a vinyl alcohol/vinyl amide co-polymer as described above and an acetoacetylated poly(vinyl alcohol) as cross linker.

When the cross linker is a polymeric resin, for example, a modified poly(vinyl alcohol), the amount of cross linking resin in the composition may exceed the weight of the vinyl alcohol/vinyl amide co-polymer. For example, the weight ratio of copolymer to polymer derived cross linker may be from about 10 to 1 to about 1 to 10. For example, in one embodiment, the composition comprises a mixture of a vinyl alcohol/vinyl amide copolymer and an acetoacetylated poly(vinyl alcohol) in a weight ratio of from about 3:1 to about 1:3, for example, a weight ratio of vinyl alcohol/vinyl amide copolymer to acetoacetylated poly(vinyl alcohol) of about 1:1 to about 1:3.

For example, one embodiment provides a method which comprises applying to at least one surface of the substrate, often as a dispersion or solution, a composition comprising

A) from about 1 to about 10 parts, of the vinyl alcohol/vinyl amide copolymer,
B) from about 1 to about 10 parts of a vinyl alcohol polymer or copolymer, for example an acetoacetylated polyvinyl alcohol, bearing groups capable of reacting with the vinyl alcohol/vinyl amide copolymer as a crosslinking agent,
C) 0 to 5, for example about 1 to about 5 parts, of a combination containing 15-70 parts, for example 25 to 50 parts, of a multifunctional acrylate, for example a di-, tri-, tetra-acrylate etc, 30-75 parts, for example 45 to 70 parts, of a photo initiator and 0-10 parts, for example 0.1 to 6 parts, of a surfactant, and
curing the composition by irradiation with UV light and/or visible light, curing the composition by exposure to heat or curing the composition by a heating step combined with an irradiation step. When the composition is applied as a solution or dispersion in solvent, a photo-curing step is typically employed.

In one embodiment, the above composition is applied as a melt to the surface of a substrate and either subsequently cured by additional heating or curing by irradiation with UV light and/or visible light. For example, a molten mixture comprising A) from about 1 to about 10 parts of the vinyl alcohol/vinyl amide copolymer, B) from about 1 to about 10 parts of a vinyl alcohol polymer or copolymer, for example an acetoacetylated polyvinyl alcohol, bearing groups capable of reacting with the vinyl alcohol/vinyl amide copolymer, and optionally C), is applied via common techniques to the surface of a substrate and then irradiated with UV light and/or visible light. For example, the composition comprises 10-90% component A and 10-90% component B by weight based on the weight of the inventive composition. It is also possible that crosslinking will occur during the thermal application of the composition.

In one particular embodiment, the above molten mixture, typically without optional component C), is extruded onto, or co-extruded with a thermoplastic polymer to provide a multilayer substrate wherein crosslinking of the composition of the invention occurs during the extrusion or co-extrusion process.

The multifunctional acrylate of component C) is most likely present in compositions which are applied as a dispersion or solution to the surface of the substrate.

The diacrylate of component C is the diester of acrylic or methacrylic acid and a diol or polyol. In the case of a diester of a polyol, free hydroxyl groups will present, which in certain instances may be further modified.

The diol component of the diacrylates include aliphatic and cycloaliphatic diols and polyols containing for example 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol; polyethylene glycols having molecular weights of for instance 200 to 1500; 1,3-cyclopentanediol, 1,2-, 1,3- or 1,4-cyclohexanediol, 1,4-dihydroxymethylcyclohexane and the like.

Polyols which may be bis esterified with acrylic or methacrylic acid include glycerol, trimethylolethane, trimethylolpropane, pentaerythritol, dipentaerythritol, sorbitol and the like.

Examples of compounds useful as the diacrylate of component C include ethylene glycol diacrylate, propylene glycol diacrylate, neopentyl glycol diacrylate, hexamethylene glycol diacrylate, polyethylene glycol diacrylate, trimethylolpropane diacrylate, pentaerythritol diacrylate, dipentaerythritol diacrylate, and the like.

Triacrylates and other polyacrylates may also be present in the composition of the present invention, for example, tri-esters, tetra-esters etc of acrylic or methacrylic acid and a polyol, for example, trimethylolpropane tri-acrylate, pentaerythritol tri-acrylate, pentaerythritol tetra-acrylate, trimethylolethane triacrylate, trimethylolpropane trimethacrylate, dipentaerythritol triacrylate, dipentaerythritol tetraacrylate, dipentaerythritol pentacrylate, dipentaerythritol hexacrylate, sorbitol triacrylate, sorbitol tetraacrylate, glycerol triacrylate, and the like.

The composition of the present invention may also include corresponding unsubstituted amides such as di and poly acrylamides and methacrylamides such hexanediacrylate, and vinyl ethers such as ethylene glycol-di-vinylether.

However, typically, when the optional components C are present, di- or other polyacrylates are present, for example, di-acrylates.

Photoinitiators suitable for use in the invention are in principle any of the compounds and mixtures that form one or more free radicals when irradiated with electromagnetic waves, for example, as described in U.S. Pat. Nos. 6,548,121, 6,048,660 and co-pending U.S. patent application Ser. No. 10/502,208, already incorporated herein in their entirety by reference. These include initiator systems consisting of a plurality of initiators and systems that function independently of one another or synergistically. In addition to co-initiators, for example amines, thiols, borates, enolates, phosphines, carboxylates and imidazoles, it is also possible to use sensitizers, for example acridines, xanthenes, thiazenes, coumarins, thioxanthones, triazines and dyes.

For example, the photoinitator may be selected from the following classes of compounds: benzoins, benzil ketals, acetophenones, halogenated acetophenones, hydroxyalkylphenones, aminoalkylphenones, acylphosphine oxides including bis-acylphosphine oxides, acylphosphine sulfides, acyloxyiminoketones, alkylamino-substituted ketones, phenylglyoxylates, dimeric phenylglyoxalates, benzophenones, oximes and oxime esters. Copolymeriazable photo-initiators, i.e., derivatives of the above chemistry containing reactable ethyleneically unsaturated groups, are also known and may be used.

It is also possible to use combinations of the compounds from the afore mentioned classes of compounds and combinations with corresponding co-initiator systems and/or sensitizers.

Specific examples of photoinitiators include acetophenone derivatives such as α-hydroxyphenylketones such as 1-hydroxycyclohexylphenylketone, 2-hydroxy-2-methyl-1-phenylpropanone or 2-hydroxy-1-[4-(2-hydroxyethoxy)phenyl]-2-methyl-1-propanone; α-amino-acetophenones such as (4-methylthiobenzoyl)-1-methyl-1-morpholino-ethane, (4-morpholinobenzoyl)-1-benzyl-1-dimethylaminopropane; 4-aroyl-1,3-dioxolanes; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)benzophenone, 4-chlorobenzophenone, 4-phenylbenzophenone, 4,4′-bis(dimethylamino)benzophenone, 4,4′-bis(diethylamino)benzophenone, methyl 2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenylbenzophenone; benzoin alkyl ethers and benzil ketals such as benzil dimethyl ketal; phenyl glyoxalates, dimeric phenyl glyoxalates and derivatives thereof, such as methylphenylglyoxylic acid ester, 5,5′-oxo-di(ethyleneoxydicarbonylphenyl) or 1,2-(benzoylcarboxy)ethane; monoacylphosphine oxides such as (2,4,6-trimethylbenzoyl)phenylphosphine oxide; bisacylphosphine oxides such as (2,6-dimethoxybenzoyl)-(2,4,4-trimethylpent-1-yl)phosphine oxide, bis(2,4,6-trimethylbenzoyl)phenylphosphine oxide or bis(2,4,6-trimethylbenzoyl)-(2,4-dipentyloxyphenyl)phosphine oxide; trisacylphosphine oxides; oxime esters such as 1-(4-phenylsulfanylphenyl)-butane-1,2-dione 2-oxime-O-benzoate, 1-(4-phenylsulfanylphenyl)-octane-1,2-dione 2-oxime-O-benzoate, 1-(4-phenylsulfanylphenyl)octan-1-one oxime-O-acetate, 1-(4-phenylsulfanylphenyl)-butan-1-one oxime-O-acetate and 1-(4-phenylsulfanylphenyl)-octane-1,2-dione 2-oxime-O-benzoate.

Co-initiators are, for example, sensitizers that shift or broaden the spectral sensitivity and as a result cause an acceleration of the photopolymerisation and include, for example, aromatic carbonyl compounds, such as, benzophenone derivatives, thioxanthone derivatives, especially also isopropylthioxanthone, anthraquinone derivatives, 3-acylcoumarin derivatives, terphenyls, styrylketones, 3-(aroylmethylene)-thiazolines, camphorquinone, and also eosin, rhodamine and erythrosine dyes.

The use and preparation of such compounds are well known to the person skilled in the art and have already been described in a large number of publications.

For example, excellent results are achieved using as component C, phenyl glyoxalates and dimeric phenyl glyoxalates as a photoinitiator along with a polyethylene glycol diacrylate. Often, a surfactant is also present along when a multifunctional acrylate and photo initiator are used.

The individual components of the invention are well known in the art, typically commercially available and/or described in the cited art incorporated herein by reference.

The composition comprising the vinyl alcohol/vinyl amide co-polymer A, cross linker B and optional components C of the present invention is prepared by any common blending or mixing technique and the components can be added in any order. More than one polymer resin of component A, crosslinker of component B or acrylate or photoinitiator of component C may be present. Other substances, for example, stabilizers, dyes, flow agents etc, often found in similar coating compositions may also be present.

For example, the components are dispersed or dissolved in a solvent or other carrier, for example, an organic solvent, water, or a mixture thereof. Most often the solvent is water or predominately water. In one embodiment, the solvent is an aqueous solvent which solvent comprises more than 75% water the rest being mainly organic solvents. Typically, the solvent is water. The amount of the composition in such a dispersion or solution is about 1% to about 50% by total weight of the composition based on the total weight of the dispersion or solution.

For example, the materials of components A, B and C can be added separately to a solvent with mixing or any two or more of the materials may be premixed prior to addition. The materials may be added neat or as a solution or dispersion in a solvent.

For example, the polymers of component A and the polymeric cross linkers of component B are often available as solutions or dispersions in water. For example, co-pending U.S. patent application Ser. No. 11/715,779, already incorporated by reference, provides vinyl alcohol/vinyl amide co-polymers of the invention in an aqueous solution. Similarly, polymeric crosslinking agents such as acetoacetylated poly(vinyl alcohol) are commercially available in aqueous solutions. Thus the compositions of the invention can be prepared by mixing a predetermined amount of the two aqueous solutions, adding any of component C or other ingredients that may be desired, and readjusting the concentration by adding additional solvent if needed.

The present composition may also be blended to form a slurry or other form of mixture.

The solution or dispersion thus prepared is then applied to the appropriate substrate by, for example, spraying, spin coating, drop coating, drawdown, brushing, dipping or any other standard coating application technique. The coating formulation may also be applied in the form of a slurry a powder.

After application, the composition is cured to effect cross linking. Typically cross linking is effected by exposure to light, i.e., UV light, visible light or a combination of UV and visible light. A number of light exposure devices and techniques for photo curing polymer containing compositions are well known in the art and may be conveniently employed. Any water or other solvent used in the application of the composition can be allowed to evaporate, either under ambient conditions or with heat and/or reduced pressure, either before or after crosslinking.

Heating may also be employed along with light exposure to effect curing, either simultaneously or stepwise. In one embodiment, a heating step and a step involving exposure to light are both employed following application of the vinyl alcohol/vinyl amide co-polymer plus cross linker composition.

Alternately, the composition is prepared by melting together the components A, B and optionally C using commonly encountered processing methods such as extrusion, co-extrusion, melt blending etc. The components may be first blended together and then added to an extruder or melt processor, or the components may be added separately to the processing equipment.

There are many variants of the invention that are hereby encompassed, some examples of which are described below, others are obvious based on the disclosure.

For example, one embodiment of the invention encompasses a method wherein a composition comprising the vinyl alcohol/vinyl amide copolymer A and from about 0.01% to about 10% by weight based on the weight of the copolymer of a cross linker compound with a molecular weight of less than about 500, is applied as a 1% to about 30% solution or dispersion in water to the surface of a substrate and then after allowing the water to evaporate the composition is cured by exposure to UV light. In another embodiment, the composition also contains 0-50%, typically, 1 to 50% by weight based on the weight of the copolymer a combination containing 15-70 parts of a multifunctional acrylate, for example a di-, tri-, tetra-acrylate etc, 30-70 parts of a photo initiator and 0-10 parts of a surfactant, (parts are parts by weight).

In another embodiment, the surface of a substrate is first subjected to a low-temperature plasma discharge or a corona discharge and then a composition comprising the vinyl alcohol/vinyl amide copolymer A, from about 0.01% to about 10% by weight based on the weight of the copolymer of a cross linker compound with a molecular weight of less than about 500, and from about 1 to about 50% by weight based on the weight of the copolymer a combination containing 15-70 parts of a multifunctional acrylate, for example a di-, tri-, tetra-acrylate etc, 30-70 parts of a photo initiator and 0-10 parts of a surfactant, is applied, and then after allowing the water to evaporate the composition is cured by exposure to UV light

Another embodiment of the invention provides a method for enhancing the gas barrier properties of a substrate, such as the oxygen, carbon dioxide or chlorine barrier properties of a substrate, in particular the oxygen barrier properties of a substrate, which method comprises applying to at least one surface of the substrate a solution or dispersion comprising, by weight based on the total weight of the dispersion or solution, from about 50% to about 99% an organic or aqueous solvent, typically the solvent is water, and from about 1% to about 50% of a the solution or dispersion a composition comprising:

A) from about 1 to about 10 parts of the vinyl alcohol/vinyl amide copolymer,
B) from about 1 to about 10 parts of a vinyl alcohol polymer or copolymer bearing groups capable of reacting with copolymer A as a crosslinking agent,
C) 0 to 5 parts, for example, from about 1 to about 5 parts of a combination containing 15-70 parts of a multifunctional acrylate, for example a di-, tri-, tetra-acrylate etc, 30-75 parts of a photo initiator and 0-10 parts of a surfactant, then
evaporating the solvent and curing the composition by irradiation with UV light and for visible light. In a related embodiment the surface of the substrate is subjected to a low-temperature plasma discharge or a corona discharge prior to applying the composition.

In one specific embodiment, the at least one least one surface of the substrate is subjected to a low-temperature plasma discharge or a corona discharge and then the surface has applied to it a solution or dispersion comprising, by weight based on the total weight of the dispersion or solution, from about 50% to about 99% of an organic or aqueous solvent, typically the solvent is water, and from about 1% to about 50% by weight based on the total weight of the dispersion or solution, of a composition comprising:

A) from about 1 to about 5 parts of the vinyl alcohol/vinyl amide copolymer
B) from about 2 to about 8 parts of a vinyl alcohol polymer or copolymer bearing groups capable of reacting with copolymer A as a crosslinking agent, and
C) from about 1 to about 5 parts of a combination containing from about 25 to about 50 parts of a di-, tri-, tetra-acrylate etc, from about 45 to about 70 parts of a photo initiator and from about 0 to about 7.5 parts of a surfactant: for example, from about 25 to about 45 parts of a di-, tri-, tetra-acrylate etc, from about 50 to about 70 parts of a photo initiator and from about 0.1 to about 6 parts of a surfactant followed by evaporating the solvent and curing the composition by irradiation with UV light and for visible light.

For example, the method comprises applying to at least one surface of the substrate a composition comprising components A, B and C wherein the weight ratio of A to B is from 1:8 to 5:2 and the weight ration of A:C is from 1:5 to 5:1.,

In one embodiment of the invention the crosslinker B comprises as a polymeric crosslinker an acetoacetylated polyvinyl alcohol.

Excellent results are achieved using an aqueous solution containing from about 1 to about 30% for example, from about 5 to about 25%, by weight of the inventive composition.

Excellent results are also achieved when the crosslinker B is a crosslinking vinyl alcohol polymer or copolymer and is present in amounts equal to or greater than the vinyl alcohol/vinyl amide copolymer, that is where the ratio of B to A is from about 1:1 to about 4:1, for example, from about 1.5 to about 4:1 or from about 2:1 to about 3.5:1.

Excellent results are also achieved when the crosslinker B is a crosslinking vinyl alcohol polymer or copolymer and the combination of component C is present in amount of less than 50% of the A, B and C composition; for example, the composition contains from about 5 to about 35% of C by weight based on the combined weight of A, B and C.

In one particular embodiment, a mixture comprising from about 1 to about 10 parts of the vinyl alcohol/vinyl amide copolymer and from about 1 to about 10 parts of an acetoacetylated polyvinyl alcohol is extruded onto or coextruded with a thermoplastic polymer to produce directly a multi-layered article wherein the vinyl alcohol/vinyl amide copolymer and acetoacetylated polyvinyl alcohol layer is crosslinked during extrusion or co-extrusion.

Upon curing, the composition of the invention forms a film, which under certain circumstances can be a free standing film. In general, the film is a coating layer which adheres strongly to the substrate to which it is applied. As a coating layer, the film of the invention can be very thin, in certain instance less than 0.01 microns, and still enhance the gas barrier properties of the substrate to which it is applied. In general however, the film thickness of the coating layer of the invention ranges from about 0.01 microns to about 100 microns thick, and often has a thickness of from about 1 micron to about 75 microns, for example from about 2 to about 50 microns.

The substrate or material onto which the composition of the present invention is applied is not particularly limited and can be almost any solid organic or inorganic material of any solid shape. When forming a stand alone layer comprising the present composition, the compositions is laid out over a surface to which it will not adhere. However, the composition is typically applied to a surface to which it will strongly adhere upon curing.

In general, the composition is applied to the surface of a synthetic or naturally occurring polymeric material. For example, the composition is applied to a synthetic organic thermoplastic, elastomeric or thermoset polymer which may also be crosslinked. The composition may be applied to another coating layer, e.g., as part of a multi-layered coating system, and other layers may be applied over the film formed by the present invention. As the films and layers of the present invention are readily printed upon, it is advisable, if overcoating is desired, that printing occur prior to any overcoating.

For example, naturally occurring or synthetic polymers include polyolefins, polyamides, polyurethanes, polyacrylates, polyacrylamides, polyvinyl alcohols, polycarbonates, polystyrenes, polyesters, polyacetals, polysulfones, polyethers, polyether ketones, poly lactic acids, cellulose ethers, cellulose esters, natural or synthetic rubbers, halogenated vinyl polymers such as PVC, alkyd resins, epoxy resins, unsaturated polyesters, unsaturated polyamides, polyimides, fluorinated polymers, silicon containing polymers, carbamate polymers and copolymers thereof.

The polymer substrate may also have incorporated therein additives such as anti-oxidants, UV absorbers, hindered amine or other light stabilizers, phosphites or phosphonites, benzofuran-2-ones, thiosynergists, polyamide stabilizers, metal stearates, nucleating agents, fillers, reinforcing agents, lubricants, emulsifiers, dyes, pigments, dispersants, optical brighteners, flame retardants, antistatic agents, blowing agents and the like, other processing agents or mixtures thereof.

Such polymers and additives are widely known items of commerce.

A particular embodiment of the invention provides a method wherein the gas barrier properties, in particular the oxygen barrier properties, of a polymeric packaging material is enhanced by application and crosslinking of the present vinyl alcohol/vinyl amide copolymer composition. Common examples of polymeric packaging materials for perishable items include thermoplastic sheets and films made from polyethylene and polypropylene, bottles and other containers made from polyesters, polyamides and other synthetic polymers. Many other examples of such materials are encountered in everyday life.

For example, in one embodiment, the packaging material is a polyester substrate, such as PET, PEN or PET or PEN copolymers. Excellent results have been achieved when PET substrates are coated using the present invention.

Poly lactic acid, PLA, is an environmentally friendly polymer which can also be used as a packaging material. Also called Polylactide polymers, PLA is derived from renewable resources and films of PLA are truly biodegradable. PLA polymers have been widely studied for use in medical applications. PLA may be a replacement for conventional synthetic packaging materials and has found use mainly in high value films, rigid thermoforms, food and beverage containers and coated papers, due in large part to higher costs. Currently PLA is used, for example, as a food packaging polymer for short shelf life products such as fruit and vegetables. One major drawback for expanding the use of PLA is its high oxygen permeability.

The present invention provides a solution for this particular problem as excellent results have also been achieved when PLA substrates are coated using the present invention.

Thus, the present invention also provides a packaging material comprising a synthetic organic polymer substrate, including but certainly not limited to a PET or PLA substrate, and a crosslinked layer adhered to its surface, which layer is a film produced according to the instant invention. For example, a PET, PLA or other polymeric substrate upon which is adhered a crosslinked film composition, which composition comprises

A) from about 1 to about 5 parts of the vinyl alcohol/vinyl amide copolymer,
B) from about 2 to about 8 parts of a vinyl alcohol polymer or copolymer bearing groups capable of reacting with copolymer A as a crosslinking agent, for example, an acetoacetylated polyvinyl alcohol,
C) from about 1 to about 5 parts of a combination containing from about 25 to about 50 parts of a di-, tri-, tetra-acrylate etc, from about 45 to about 70 parts of a photo initiator and from about 0 to about 7.5 parts of a surfactant: for example, from about 25 to about 45 parts of a di-, tri-, tetra-acrylate etc, from about 50 to about 70 parts of a photo initiator and from about 0.1 to about 6 parts of a surfactant.

The synthetic organic polymer substrate can be of almost any thickness, shape and form. In many cases, the substrate when used as a packaging material will be a film or molded article such as a bottle, but sheets and other materials are also employed, perhaps as part of a carton. Thus, in one embodiment, the substrate is a film of for 2 microns to 50 or 100 microns thick, in another embodiment the substrate is a plastic bottle, etc.

In the practice of the invention it has been found that good improvements in, for example, oxygen barrier properties can often be obtained by applying to a polymer substrate a solution or dispersion of a composition containing the vinyl alcohol/vinyl amide copolymer A and cross linker B, in particular a vinyl alcohol polymer or copolymer such as acetoacetylated polyvinyl alcohol as B, without any of the optional component C followed by exposure to UV and/or visible light. It has been found that UV curing of such systems, even without the presence of photo initiators, often provides superior adhesion of the film than thermal curing of similar systems containing thermally active crosslinking agents when applied as a solution or dispersion.

However, adhesion of the film of the invention to the substrate when applied as a solution or dispersion, as well as adhesion of an ink to the film of the invention, is often improved further by the presence of the mixture of component C in the composition, by subjecting the surface of the substrate to a low-temperature plasma discharge or a corona discharge before application of the composition, or both.

The present method will improve, for example, the oxygen barrier properties of a substrate, such as a polymeric film, at low humidity and will also show an improvement over the use of conventional PVOH polymers at high humidities. In addition, the present method is simple to employ and provides film that is active even at very low thickness and is readily printed upon with good ink durability using any common printing technique.

As many embodiments of the instant invention employ a water soluble composition, a gas barrier film can be produced without using an organic solvent which offers advantages regarding environmental and safety issues. Also, in many embodiments no dispersant is used, and when a dispersant is used the amount is very low.

Thus, the method of the present invention provides, for example, a packaging material which has high gas barrier properties, i.e., oxygen barrier properties, even in high humidity, prepared using safe and environmentally friendly materials and procedures.

Another embodiment of the invention relates to novel compositions useful in forming films with excellent gas barrier characteristics, for example, a novel composition comprising:

A) 1 to 10 parts by weight of a vinyl alcohol/vinyl amide co-polymer comprising monomer units of formulae (I) and (II)

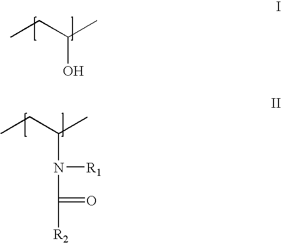

wherein R₁ and R₂ are independently H or C₁-C₁₂ alkyl, for example H or C₁-C₆ alkyl, for example at least one of R₁ and R₂ is H, often both are H;
which copolymer contains less than 2 mole percent, for example from 0-2% or 0-1% of a repeating unit containing an amino group of formula III,

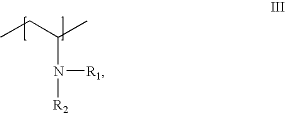

wherein R₁ is H or C₁-C₁₂ alkyl and R₂ is H,
B) 1 to 10 parts by weight of a vinyl alcohol polymer or copolymer bearing groups capable of reacting with copolymer A, for example, a modified poly(vinyl alcohol) such as an acetoacetylated poly(vinyl alcohol),
C) 0 to 5 parts by weight, for example 1 to 5 parts by weight, of a multifunctional acrylate, for example a di-, tri-, tetra-acrylate etc, and/or a photo initiator, for example a phenyl glyoxalate.

This composition can also be a solution or dispersion in an organic or aqueous solvent as above and can form a free standing film with excellent gas barrier properties or be applied to the surface of a substrate forming a coating with excellent gas barrier properties when cured by applying heat, irradiation by UV light, visible light, IR irradiation and/or electron beam.

The gas barrier film and the packaging material thus obtained have good gas barrier properties even in high humidity, have high safety and are available at a low cost since they can easily be produced, and they are useful for various applications such as food application, medicine application and industrial application.

### Examples

In the following examples,

GLASCOL R910 is a commercially available vinyl alcohol/vinyl amide co-polymer prepared according to co-pending U.S. patent application Ser. No. 11/715,779, containing between about 6 and about 12 mole % vinyl amide monomer
GOSEFIMER Z-410 is a commercially available acetoacetylated poly(vinyl alcohol)
EPICROSS WS500 and EPICROSS CR5L are commercially available thermal crosslinking agents.

### Coated PET Films

The coating formulations 1-9, see table below, are prepared as aqueous solutions at 10% by weight total solids, the solutions are then applied using conventional drawdown techniques to PET films and dried to form 20 micron coatings. The samples prepared from formulations 2, 3, 5 and 6 are thermally crosslinked; the samples prepared from formulations 7-9 are crosslinked by exposure to radiation from a FUSION H&V BULB at a dose of 1,500 my in ambient atmosphere. Each coated film is then subjected to a simple wet double rub test to test water sensitivity. The number of wet double rubs needed to remove the film are shown in the final column of the table below.

Water Sensitivity

| | % Glascol | % Gohsefimer | | |
|---|---|---|---|---|
| Formulation | R910 | Z-410 | Thermal Crosslinker | # Rubs |
| 1 | — | 100 | — | 5 |
| 2 | — | 95 | 5% Epicross CR5L | 10-15 |
| 3 | — | 95 | 5% Epicross WS500 | 10-15 |
| 4 | 100 | — | — | 3-5 |
| 5 | 95 | — | 5% Epicross CR5L | 10 |
| 6 | 95 | — | 5% Epicross WS500 | 10 |
| 7 | 25 | 75 | — | >30 |
| 8 | 50 | 50 | — | 20-25 |
| 9 | 75 | 25 | — | 15-20 |

All the cross linked coatings demonstrate less water sensitivity than the non-crosslinked coatings 1 and 4 as demonstrated by the number of rubs needed to remove the coating. The UV cross linked coatings 7-9 are superior in water resistance to the thermally crosslinked coatings 2, 3, 5 and 6 when applied using this method and the above materials.

### Oxygen Permeability

The UV cured samples prepared from formulation 7-8 were tested for OXYGEN BARRIER properties at 0% relative humidity and 60-70% relative humidity. While performance of the films is better at low humidity, each coated film show good to excellent performance relative to uncoated PET film at both humidity levels.

### Coated PLA Films

The following aqueous solutions are prepared using GLASCOL R910 (available as a 10% aqueous solution) as Component A, GOSEFIMER Z-410 (available as a 10% aqueous solution) as Component B, and as component C a mixture of 34.2% Polyethylene Glycol 400 Diacrylate as multifunctional acrylate, 61.0% polymeric Phenyl Glyoxylate as photo initiator and 4.8% of a surfactant as shown in the following table. Parts are by weight, each formulation is diluted to 100 total parts with water.

Each formulation is coated onto a Corona treated polylactic acid film (EARTHFIRST™ PLA, SIDAPLAX, s.t.:52 dyne/cm) at 12 micron thickness after drying using the appropriate MAYER bar and standard draw down techniques and then cured using a 200 W/cm m.p. mercury lamp, curing speed: 35 m/min. Water sensitivity is again measured using a wet double rub test and Adhesion is measured using a standard tape test, the percentage of film removed is given.

| Formulation | Comp. A | Comp. B | Comp. C | #Rubs | Tape Test |
|---|---|---|---|---|---|
| 10 | 2.6 | 7.4 | 0 | 10-15 | >50% |
| 11 | 1.3 | 3.7 | 0 | 5-10 | >50% |
| 12 | 2.6 | 7.4 | 1 | 20-25 | 0% |
| 13 | 2.6 | 7.4 | 2 | 5-10 | 0% |
| 14 | 2.6 | 7.4 | 5 | 15-20 | 10-20% |
| 15 | 1.3 | 3.7 | 1 | 5-10 | 20% |
| 16 | 2.3 | 6.7 | 1 | 10-15 | 0% |
| 17 | 1.7 | 5.0 | 3.3 | 15-20 | 0% |
| 18 | 1.3 | 3.7 | 5 | 5-10 | 0% |

*Formulation 10 was also thermally cured at 50° C. for 5 minutes in a separate test took 5 rubs or less to remove the film.

### Ink Adhesion

Each formulation 10-18 is coated onto a Corona treated polylactic acid film (EARTHFIRST™ PLA, SIDAPLAX, s.t.:52 dyne/cm) at 4 micron thickness and UV cured as above. The samples are then printed on with FLINT GROUP UV cyan flexo ink and the ink is UV cured using the same conditions as the film. All experimental coating formulations show excellent printability. Evaluation of adhesion performance is measured by a standard tape test (1 minute time interval).

Formulations 10, 11 show somewhat poorer ink adhesion, 50% or more ink removed), Formulation 15 demonstrate better in adhesion, about 20% ink removed Formulations 12-14 and 16-18 show excellent ink adhesion, 0% ink removed.

### Oxygen Permeability

Formulations 10, 12 and 17 are again coated onto corona treated polylactic acid film (EARTHFIRST™ PLA, SIDAPLAX, s.t.:52 dyne/cm) as above to form 12 micron thick crosslinked films. Samples of each plus samples of untreated PLA are tested for oxygen permeability by measuring the oxygen transmission rate (OTR) following ASTM procedures at 0% and 70% humidity. The results are given in the table below. While there some variance in the readings at high humidity, all coated samples not only greatly outperform the PLA standard, but show good oxygen barrier properties even at high humidity (lower numbers is less oxygen permeation).

Oxygen permeability results at T:23° C. at 0% and 70% humidity.

| | | OTR | OTR |
|---|---|---|---|
| | | cc/m2 24 h atm | cc/m2 24 h atm |
| | | 23° C. - 70% RH | 23° C. - 70% RH |
| | OTR | ASTM F 1927-07 | ASTM F 1927-07 |
| | cc/m2 24 h atm | Coated side | Coated side |
| | 23° C. - 0% RH | in contact | in contact |
| Formulation | ASTM D3985 | with 70% RH | with 0% RH |
| PLA Standard | 366.9 | 357.5 | — |
| (No coating) | 372.3 | 370.4 | — |
| | 369.0 | 357.5 | — |
| 10 | 5.5 | 80.8 | 1.3 |
| | 1.6 | 59.4 | 3.2 |
| | 2.8 | 61.0 | |
| 12 | 1.6 | 7.0 | 6.1 |
| | 1.6 | 5.3 | 2.8 |
| | 2.8 | 58.0 | |
| 17 | 27.7 | 58.1 | 44.4 |
| | 38.5 | 210.8 | 53.3 |
| | 58.5 | 229.2 | |

1. A method for enhancing the gas barrier properties of a substrate, which method comprises applying to at least one surface of the substrate a composition comprising:
A) a vinyl alcohol/vinyl amide co-polymer comprising monomer units of formulae (I) and (II) 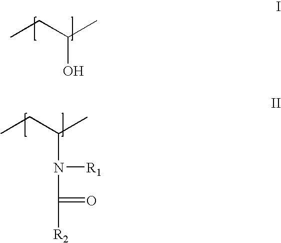
wherein R₁ and R₂ are independently H or C₁-C₁₂ alkyl, which copolymer contains less than 6 mole percent of a repeating unit containing an amino group of formula III, 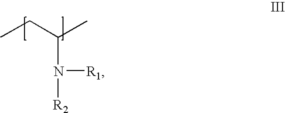
B) a cross linker containing groups capable of reacting with the vinyl alcohol/vinylamide copolymer,
C) optionally a mixture of a multifunctional acrylate and a photo initiator,
and exposing the composition to irradiation with UV light, visible light, electron beam and/or heat to effect cure.

2. A method according to claim 1 wherein the at least one surface of the substrate is subjected to a low-temperature plasma discharge or a corona discharge prior to applying the composition.

3. A method according to claim 1, wherein in the vinyl alcohol/vinyl amide co-polymer R₁ and R₂ are H and the photoinitiator is a phenyl glyoxalate photo initiator.

4. A method according to claim 1 wherein the vinyl alcohol/vinyl amide co-polymer is of the general formula 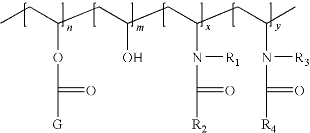
wherein
n is from about 0 to about 20 mole %,
m is from about 50 to about 99 mole %,
x is from about 1 to about 50 mole %, and
y is from about 0 to about 20 mole percent.

5. A method according to claim 1, which method comprises applying to at least one surface of the substrate a composition comprising
A) the vinyl alcohol/vinyl amide copolymer,
B) 0.01% to about 10% by weight based on the weight of the vinyl alcohol/vinyl amide copolymer of a cross linker compound with a molecular weight of less than about 500, and
C) 0 to 50% by weight based on the weight of the copolymer of a combination containing 15-70 parts of a di-, tri- or tetra-acrylate, 30-70 parts of a photo initiator and 0-10 parts of a surfactant
and
curing the composition by exposure to UV light, visible light and/or heat.

6. A method according to claim 1, which method comprises applying to at least one surface of the substrate a composition comprising
A) from about 1 to about 10 parts of the vinyl alcohol/vinyl amide copolymer,
B) from about 1 to about 10 parts of a vinyl alcohol polymer or copolymer bearing groups capable of reacting with the vinyl alcohol/vinyl amide copolymer as a crosslinking agent,
C) 0 to 5 parts of a combination containing 15-70 parts of a di-, tri- or tetra-acrylate, 30-75 parts of a photo initiator and 0-10 parts of a surfactant and
curing the composition by exposure to UV light, visible light and/or heat.

7. A method according to claim 6, which method comprises applying to at least one surface of the substrate a composition comprising
A) from about 1 to about 10 parts of the vinyl alcohol/vinyl amide copolymer,
B) from about 1 to about 10 parts of a vinyl alcohol polymer or copolymer bearing groups capable of reacting with the vinyl alcohol/vinyl amide copolymer as a crosslinking agent,
C) 1 to 5 parts of a combination containing from about 25 to about 50 parts of a di-, tri- or tetra-acrylate, from about 45 to about 70 parts of a photo initiator and from about 0.1 to about 6 parts of a surfactant.

8. A method according to claim 1, wherein the composition comprising components A, B and C is applied as a 1% to 50% solution or dispersion by weight based on the total weight of the dispersion or solution in an organic or aqueous solvent.

9. A method according to claim 8 wherein the composition is applied as a solution or dispersion in water.

10. A method according to claim 1, wherein the crosslinker comprises an acetoacetylated polyvinyl alcohol.

11. A method according to claim 6, wherein the crosslinker comprises an acetoacetylated polyvinyl alcohol.

12. A method according to claim 1, wherein the substrate is a synthetic thermoplastic, elastomeric or thermoset organic polymer.

13. A method according to claim 12 wherein the synthetic thermoplastic, elastomeric or thermoset organic polymer is a polyethylene terephthalate or a poly lactic acid.

14. A method according to claim 12 wherein the composition comprises from about 1 to about 10 parts of the vinyl alcohol/vinyl amide copolymer and from about 1 to about 10 parts of a vinyl alcohol polymer or copolymer bearing groups capable of reacting with the vinyl alcohol/vinyl amide copolymer as a crosslinking agent, and is applied to the substrate by extrusion or co-extrusion.

15. A method according to claim 14 wherein the composition comprises from about 1 to about 10 parts of the vinyl alcohol/vinyl amide copolymer and from about 1 to about 10 parts of an acetoacetylated polyvinyl alcohol.

16. A method according to claim 14 wherein crosslinking occurs during extrusion or co-extrusion.

17. A flexible packaging material obtained by the method according to claim 1.

18. A composition comprising
A) 1 to 10 parts by weight of a vinyl alcohol/vinyl amide co-polymer comprising monomer units of formulae (I) and (II) 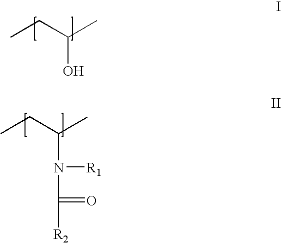
wherein R₁ and R₂ are independently H or C₁-C₁₂ alkyl;
which copolymer contains 0 to 2 mole percent of a repeating unit containing an amino group of formula III, 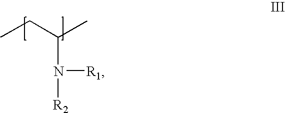
wherein R₁ is H or C₁-C₁₂ alkyl and R₂ is H,
B) 1 to 10 parts by weight of an acetoacetylated poly(vinyl alcohol),
C) 0 to 5 parts by weight of a combination of a di-, tri-, tetra or acrylate, and/or a photo initiator.

19. A composition according to claim 15, wherein the vinyl alcohol/vinyl amide co-polymer contains 0 to 1 mole percent of a repeating unit containing an amino group of formula III.

20. A composition according to claim 15, which comprises as C) 1 to 5 parts by weight of a combination of a di-, tri-, tetra or acrylate, and/or a phenylglyoxalate photo initiator.

21. A method according to claim 1 for enhancing the oxygen barrier properties of a substrate.
